(19) United States
(12) Patent Application Publication
(10) Pub. No.: US 2011/0244436 A1
(43) Pub. Date: Oct. 6, 2011

(54) Incision and drainage simulator

(76) Inventor: Theresa M. Campo, Ocean View, NJ (US)

(21) Appl. No.: 12/662,157

(22) Filed: Apr. 1, 2010

(51) Int. Cl. G09B 23/30; G09B 23/28

(52) U.S. Cl. 434/263; 434/262; 434/267

(57) ABSTRACT

An incision and drainage simulator wherein a styrofoam base has a plurality of recesses formed in the top surface thereof for receiving a respective liquid sac. A flexible sheet having indicia representing various anatomic or dental abscess locations is detachably connected to the top surface of the base. The indicia is aligned with a liquid sac positioned in a respective recess. The styrofoam base is positioned in a container having individual compartments for containing the various medical equipment employed while using the incision and drainage simulator to thereby provide a kit.

### BACKGROUND OF THE INVENTION

Practicing the removal of lesions, such as sebaceous cysts or other subcutaneous growths, are fundamental practices in the training of medical students and experienced practitioners. Surgery practice techniques presently in use have been characterized by various inadequacies or deficiencies that render them of limited usefulness or desirability for use.

Currently there are no realistic simulators for this procedure. The use of hot dogs with artificial nails and chicken breasts with “Elmer's Glue” are the methods used to teach this procedure in an inexpensive manner. Human cadavers are an alternative used in colleges and universities, but the use of cadavers can be cost prohibitive, especially in today's economy.

### SUMMARY OF THE INVENTION

After considerable research and experimentation, the incision and drainage simulator of the present invention has been devised wherein a student or experienced practitioner can learn the procedure of incision and drainage of a cutaneous/subcutaneous abscess, such as pilonidal, paronychia, felon, bartholin gland or dental.

The simulator of the present invention comprises, essentially, a styrofoam base having a plurality of recesses formed in the top surface thereof, a liquid sac positioned in each of the recesses, and a flexible sheet detachably connected to the top surface of the base. Indicia representing various anatomic abscess locations are printed on the flexible sheet aligned with the liquid sac positioned in a respective recess. The styrofoam base is positioned in a container having individual compartments for containing the various medical equipment employed while using the incision and drainage simulator to thereby provide a kit.

### BRIEF DESCRIPTION OF THE DRAWINGS:

FIG. 1 is a perspective view of the incision and drainage simulator of the present invention;

FIG. 2 is an exploded view of the simulator shown in FIG. 1;

FIG. 3 is a sectional view taken along line 3-3 of FIG. 1;

FIG. 4 is a sectional view taken along line 4-4 of FIG. 1;

FIG. 5 is a sectional side-elevational view of a liquid sac simulating a cyst;

FIG. 6 is a fragmentary, perspective view of the simulated cyst being cut and drained; and,

FIG. 7 is a perspective view of a dental incision and drainage simulator.

### DETAILED DESCRIPTION OF THE INVENTION:

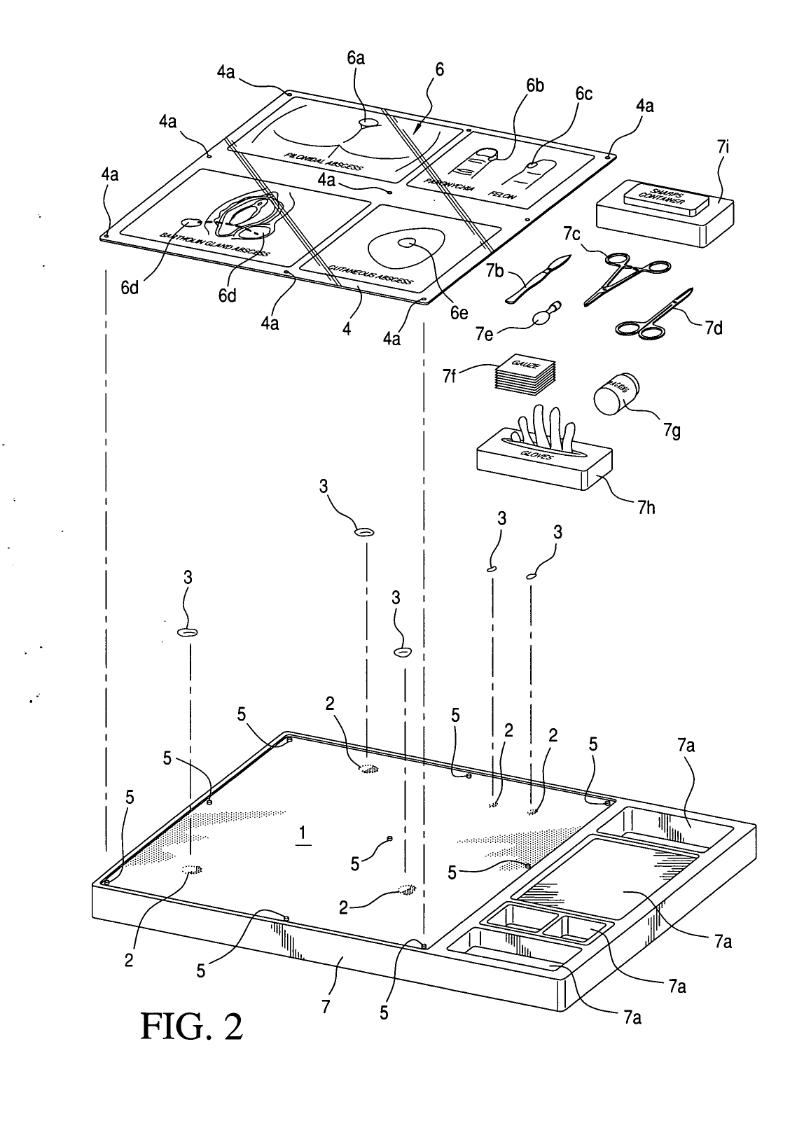

Referring to the drawings, and more particularly to FIGS. 2, 3 and 4, the incision and drainage simulator of the present invention comprises a styrofoam base 1 having a plurality of recesses 2 formed in the top surface thereof. A liquid sac 3 is positioned in each of the recesses 2, and a flexible sheet 4 is detachably connected to the top surface of the base 1 by upwardly extending pins 5 embedded in the top surface of the base and insertable into apertures 4a provided in the flexible sheet 4.

Indicia 6 are printed on the top surface of the flexible sheet 4 representing various anatomic abscess locations, such as pilonidal abscess 6a, paronychia, felon abscesses 6b, 6c, bartholin gland abscess 6d, and a cutaneous abscess 6e.

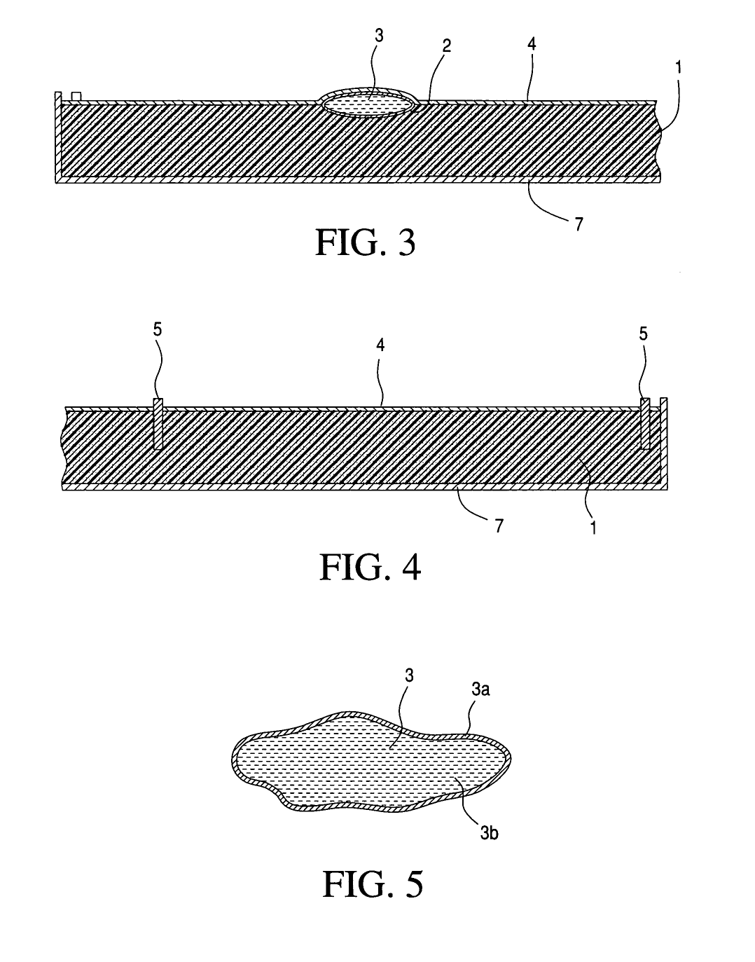

As will be seen in FIGS. 3 and 5, the liquid sac 5 comprises a flexible liquid impervious pliable envelope 3a containing a white viscous gel 3b, and the flexible sheet 4 can be made of plastic or rubber.

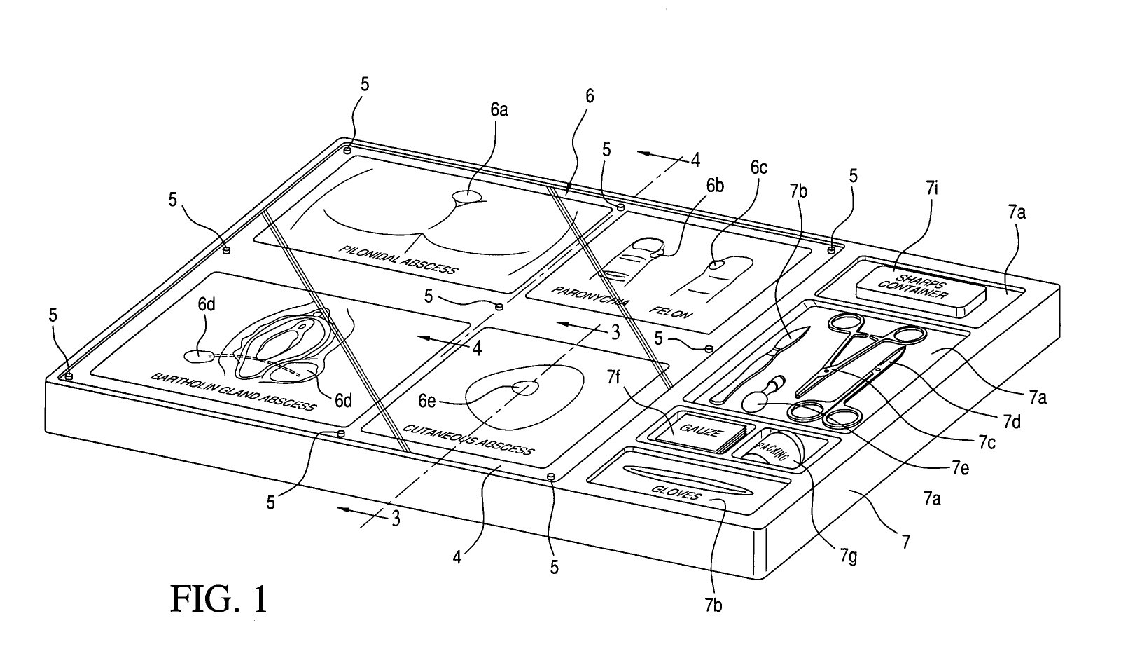

As will be seen in FIGS. 1 and 2, the styrofoam base 1 is placed in a container 7 having individual compartments 7a for containing the various equipment used in the practice of incision and drainage, such as a scalpel 7b, a hemostat 7c, scissors 7d, a suction catheter 7e, gauze 7f, packing 7g, disposable gloves 7h and a sharps container 7i, to thereby provide a kit.

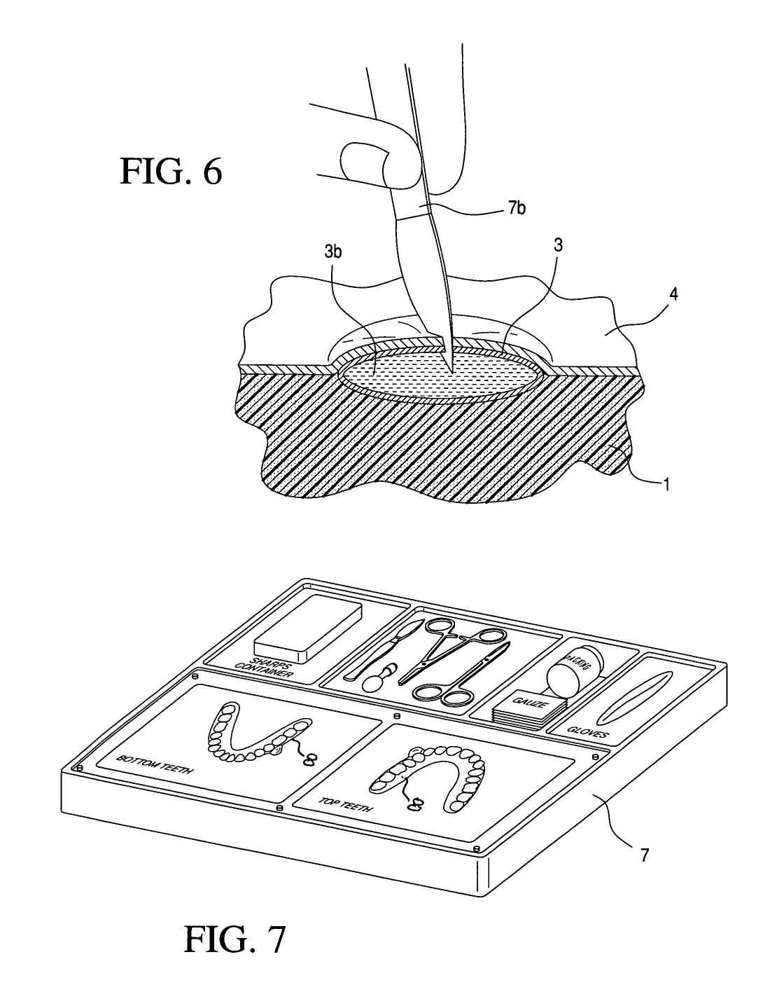

Referring to FIG. 6, when using the simulator, the student or practitioner uses the scalpel 7b to cut an incision through the flexible sheet 4 and liquid sac 3 to thereby facilitate the draining of the gel 3b from the sac 3.

While the simulator of the present invention has been described for the incision and drainage of various anatomic abscesses, FIG. 7 illustrates a kit similar to that of FIGS. 5, 1 and 2; however, having dental indicia 8 printed on the flexible sheet 4.

In use, a student or practitioner would cut an incision in each of the liquid sacs 3 positioned in each of the respective anatomical or dental locations, and drain the liquid therefrom. After the sheet 4 has been used, it can be replaced by a new sheet 4 inserted on to the pins 5.

From the above description, it will be apparent to those skilled in the art that the simulator kit of the present invention provides a workstation which is re-usable and mobile so that it can be used not only in a classroom, but also in an individual's home or office.

It is to be understood that the form of the invention herewith shown and described is to be taken as a preferred example of the same, and that various changes in the shape, size and arrangement of parts may be resorted to without departing from the spirit of the invention or scope of the subjoined claims.

I claim:

1. An incision and drainage simulator comprising a styrofoam base, a plurality of recesses formed in the top surface of said base, a liquid sac positioned in each of said recesses, a flexible sheet, means for detachably connecting said sheet to the top surface of said base, and indicia representing various abscess locations printed on the flexible sheet and aligned with a sac positioned in a respective recess.

2. An incision and drainage simulator, according to claim 1, wherein the means for detachably connecting the sheet to the top surface of the base comprises a plurality of vertically extending pins embedded in the top surface of the base, holes provided in said flexible sheet, said pins extending through said holes.

3. An incision and drainage simulator, according to claim 1, wherein the indicia represents various anatomic abscess locations comprising a pilonidal abscess, paronychia and felon abscesses, a bartholin gland abscess and a cutaneous abscess.

4. An incision and drainage simulator, according to claim 1, wherein the indicia represents dental abscess locations.

5. An incision and drainage simulator, according to claim 1, wherein the styrofoam base is placed in a container, a plurality of compartments provided in said container, various equipment used in the practice of incision and drainage contained in said compartments, to thereby provide a kit.
